(19) United States
(12) Patent Application Publication
(10) Pub. No.: US 2022/0366028 A1
(43) Pub. Date: Nov. 17, 2022

(54) METHOD AND SYSEM FOR FINGERPRINT VERIFICATION AND ENROLLMENT WITH SECURE STORAGE OF TEMPLATES

(71) Applicant: PRECISE BIOMETRICS AB, Lund (SE)

(72) Inventor: Petter Österlund, Karlstad (SE)

(73) Assignee: PRECISE BIOMETRICS AB, Lund (SE)

(21) Appl. No.: 17/755,618

(22) PCT Filed: Nov. 5, 2020
(86) PCT No.: PCT/EP2020/081175

§ 371 Date: May 3, 2022

(30) Foreign Application Priority Data
Nov. 6, 2019 (SE) 1951273-0

(51) Int. Cl. G06F 21/32; G06V 40/12; G06V 40/50

(52) U.S. Cl. CPC G06F 21/32; G06V 40/1347; G06V 40/1365; G06V 40/50

(57) ABSTRACT

A method (600) for fingerprint verification of a user is presented. The method (600) comprises receiving (602) a sample (108) of a fingerprint from the user, extracting (604) key points (204) from the sample (108), extracting (606) descriptors (202) from the sample (108), wherein the descriptors (202) are based on information gathered from areas surrounding the key points (204), retrieving (608) enrolled descriptors (302), matching the descriptors (202) and the enrolled descriptors (302), thereby forming a list (304) of matching descriptor pairs, transferring (610) the list (304) of matching descriptor pairs and the key points (204) from a first module (104) to a second module (106), retrieving (614) enrolled key points (308), matching (616) the key points (204) and the enrolled key points (308) in combination with the list (304) of matching descriptor pairs, and in case of match (618), signaling (620) a positive verification outcome using the second data communications device (122), else, signaling (622) a negative verification outcome using the second data communications device (122).

### TECHNICAL FIELD

The invention relates to fingerprint verification technology. More particularly, it is presented a method for fingerprint verification, a method for fingerprint enrollment, a first and a second module for fingerprint verification, and a system comprising the first and second module.

### BACKGROUND ART

Fingerprint verification technology is today part of everyday life for millions of people worldwide. For instance, many mobile phones of today are provided with a fingerprint sensor for providing the possibility to a user to instead of using a PIN code, using his or her finger for verifying that he or she is a rightful owner of the phone. In addition to locking and unlocking the mobile phone, fingerprint verification technology can be used as part of a payment process. Besides providing convenience, an advantage of using fingerprint verification technology instead of PIN codes is that the security level is increased.

Using fingerprint verification technology comes however with a number of challenges. First and foremost, the technology must assure that a risk for incorrect matches between a sample of the fingerprint and a template is at very low levels. Put differently, a number of false positives should be kept low. Further, a number of false negatives should also be kept low, that is, the risk that a user, being the rightful owner, is considered not to be the rightful owner, should be kept low. As can easily be understood, balancing these two requirements against each other is challenging. In addition to keeping false positives and false negatives low, there are requirements in terms of e.g. speed, space and memory usage. To address these challenges different types of sensors and algorithms have been developed, such as capacitive sensors and minutiae matching algorithms.

In addition to having sensors and algorithms that assure low levels of false positives and false negatives, how the template is stored needs to be addressed. In case the template is not securely stored, there is a risk that the template is retrieved and misused by persons not being entitled to using the template.

Even though the problems associated with providing fingerprint verification technology are well known, there is still a need for fingerprint technology that provides secure storage of the template and improved response time in a cost-efficient manner.

### SUMMARY

It is an object of the invention to at least partly overcome one or more of the above-identified limitations of the prior art. In particular, it is an object to provide fingerprint technology with improved response time and secure storage of the template in a cost-efficient manner.

According to a first aspect it is provided a method for fingerprint verification of a user by using a system comprising a first module provided with a first processor, a first memory and a first data communications device, and a second module provided with a second processor, a second memory and a second data communications device, the method comprising receiving a sample of a fingerprint from the user by the first module, extracting key points from the sample using the first processor, extracting descriptors from the sample using the first processor, wherein the descriptors may be based on information gathered from areas surrounding the key points, retrieving enrolled descriptors from the first memory, matching the descriptors and the enrolled descriptors using the first processor, thereby forming a list of matching descriptor pairs, transferring the list of matching descriptor pairs and the key points from the first module to the second module using the first and second data communications device, retrieving enrolled key points from the second memory, matching the key points and the enrolled key points in combination with the list of matching descriptor pairs using the second processor, and in case of match, signaling a positive verification outcome using the second data communications device, else, signaling a negative verification outcome using the second data communications device.

The positive verification outcome may be a binary statement of match, but it may also be more detailed output comprising information about the verification. Further, in case e.g. the second module is a smart card, the positive verification outcome may also be an indication that the verification was successful and that crypto keys and functions on the smart card is made available for external software. In a similar manner, the negative verification outcome may be a binary statement of no match, a more detailed output or an indication that the verification was not successful.

The descriptors may be based on the key points. More particularly, the descriptors may be based on information gathered from areas surrounding the key points. For instance, if a swirl center of the finger print is identified as the key point, an area surrounding the swirl center may be used as basis for the descriptor. Each key point may be a point. In addition, each key point may comprise a direction. Thus, each key point may be a point with or without a direction.

The step of extracting sample descriptors from the sample by using the first processor may be performed by using a general-purpose image analysis algorithm for identifying descriptors, and wherein the step of extracting sample key points from the sample by using the first processor may be performed by using a fingerprint specific algorithm for identifying key points and the position data and the direction data associated to the key points.

For each descriptor of the sample descriptors and the enrolled descriptors, a combination of features related to any one selected from a group consisting of colour, texture, shape, motion and location may be provided.

The step of matching the descriptors and the enrolled descriptors may be performed such that each descriptor of the sample descriptors may be compared or matched with each descriptor of the enrolled descriptors. Thus, the matching of the descriptors and the enrolled descriptors may be a performed by using a brute force algorithm. Using the brute force algorithm most often comes with a high data processing cost, i.e. several processor operations may be required to perform this matching. Since the descriptors in most implementations do not contain sensitive data, using the descriptors outside a secure element or other similar element for securely handling sensitive data can be made without creating vulnerabilities. This in turn provides for that the brute force algorithm can be made by using a processor outside the secure element or other similar element.

The step of matching the key points and the enrolled key points in combination with the list of matching descriptor pairs comes with the advantage that this can be made very efficiently such that a low-capacity processor, such as a processor of a secure element, can be used. Having the pairs of descriptors provides an advantage in that this provides guidance regarding how the key points, i.e. the key points extracted from a sample, and the enrolled key points, i.e. the key points extracted from a template and stored in the second memory, which may be a memory of the secure element, can be combined. It has been found that to provide an efficient matching of the key points in terms of data processing cost as well as reducing a risk for false acceptance, i.e. imposters, a random sample consensus (RANSAC) algorithm can be used for the key point matching.

In line with above, the step of matching the descriptors and the enrolled descriptors may need a greater processor capacity compared to the step of matching the key points and the enrolled key points in combination with the list of matching descriptors. Thus, the brute force algorithm may need a greater processor capacity compared to the key point matching, and if using RANSAC for matching the key points even less. Since the descriptors does not contain sensitive data the first processor, e.g. the processor used outside the secure element, may be a general-purpose processor of a micro-controller unit (MCU) without any special considerations made regarding the data being handled.

However, it should be noted that the matching of the descriptors and the enrolled descriptors may be performed by using other types of algorithms than the brute force algorithm. It should further be noted that the matching of the key points with the enrolled key points in combination with the list of matching descriptor pairs may be performed by using other types of algorithms than the RANSAC algorithm.

An operating speed of the first processor may be greater than an operating speed of the second processor.

The first module may have a memory capacity that is greater than the second module. Since the descriptors may comprise more data than the key points, it can be advantageous to store the descriptors in the first module. The first module may be a micro-controller unit (MCU) and the second module may be a secure element (SE).

The first module and the second module may be provided on a smart card.

According to a second aspect it is provided a method for fingerprint enrollment of a user by using a system comprising a first module provided with a first processor, a first memory and a first data communications device, and a second module provided with a second processor, a second memory and a second data communications device, the method comprising receiving a sample of a fingerprint from the user by the first module, extracting key points from the sample using the first processor, extracting descriptors from the sample using the first processor, wherein the descriptors may be based on information gathered from areas surrounding the key points, enrolling the descriptors to the first memory, thereby forming enrolled descriptors, transferring the key points from the first module to the second module, and enrolling the key points to the second memory, thereby forming enrolled key points.

According to a third aspect it is provided a first module, such as a micro-controller unit (MCU), comprising a first processor, a first memory and a first data communications device, wherein the first module is configured to receive a sample of a fingerprint from the user by the first module, extract key points from the sample using the first processor, extract descriptors from the sample using the first processor, retrieve enrolled descriptors from the first memory, match the descriptors and the enrolled descriptors using the first processor, thereby forming a list of matching descriptor pairs, and transfer the list of matching descriptor pairs and the key points from the first module to a second module, such as a secure element (SE), comprising a second processor, a second memory, and a second data communications device, wherein the second module is configured to receive the list of matching descriptor pairs and the key points from the first module according to the third aspect using the second data communications device, retrieve enrolled key points from the second memory, match the key points and the enrolled key points in combination with the list of matching descriptor pairs, and in case of match, signal a positive verification outcome using the second data communications device, else, signal a negative verification outcome using the second data communications device.

The second module, such as the secure element, may comprise the second processor, the second memory, and the second data communications device, wherein the second module may be configured to receive the list of matching descriptor pairs and the key points from the first module according to the third aspect using the second data communications device, retrieve enrolled key points from the second memory, match the key points and the enrolled key points in combination with the list of matching descriptor pairs, and in case of match, signal a positive verification outcome using the second data communications device, else, signal a negative verification outcome using the second data communications device.

According to a fourth aspect it is provided a system comprising a first module according to a third aspect, and a second module according to the fourth aspect.

The system may be a smart card.

The system may further comprise a finger print reader for capturing the sample of the fingerprint.

The system may be part of a payment solution.

According to fifth aspect it is provided a computer program product comprising instructions which, when the program is executed by a first module and a second module, cause the first module and the second module to carry out the steps of the method according to the first aspect.

According to a sixth aspect it is provided a computer program product comprising instructions which, when the program is executed by a first module and a second module, cause the first module and the second module to carry out the steps of the method according to the second aspect.

Still other objectives, features, aspects and advantages of the invention will appear from the following detailed description as well as from the drawings.

### BRIEF DESCRIPTION OF THE DRAWINGS

Embodiments of the invention will now be described, by way of example, with reference to the accompanying schematic drawings, in which

FIG. 1 is a general illustration of a system for fingerprint verification and fingerprint enrollment.

FIG. 2 is a more detailed illustration of the system during fingerprint enrollment.

FIG. 3 is a more detailed illustration of the system during fingerprint verification.

FIG. 4 illustrates another embodiment of the system.

FIG. 5 is a flowchart illustrating a method for fingerprint enrollment.

FIG. 6 is a flowchart illustrating a method for fingerprint verification.

### DETAILED DESCRIPTION

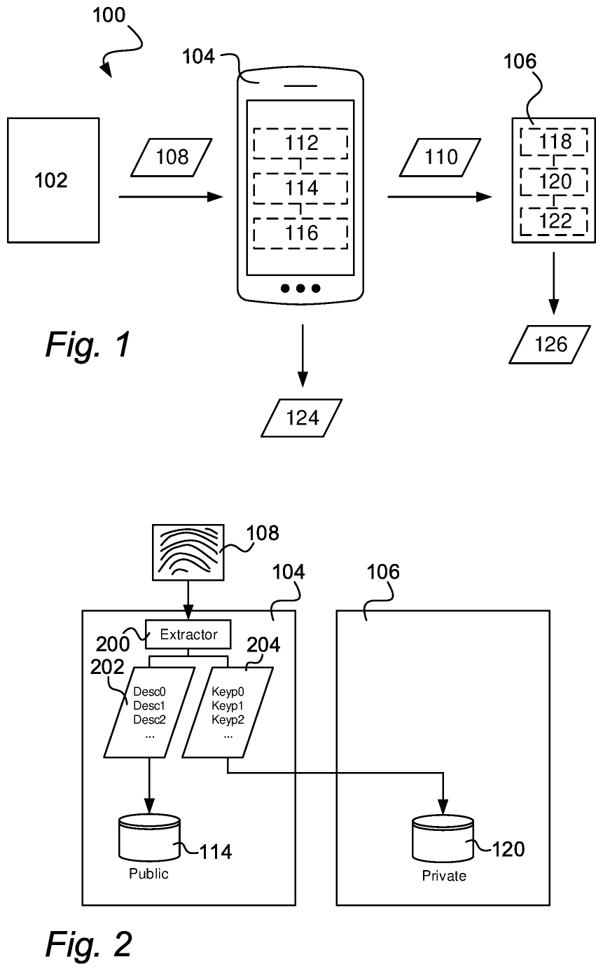

FIG. 1 generally illustrates a system 100 for fingerprint verification by way of example. The system 100 comprises a fingerprint reader 102, a first module 104, herein exemplified by a mobile phone, and a second module 106, herein exemplified by a secure element (SE). After a sample 108 is captured by the fingerprint reader 102 this can be transferred to the first module 104. In the first module 104, a first part of the verification can be performed, as described more in detail below. After having performed this first part, extracted sample data 110 can be transferred from the first module 104 to the second module 106. To perform the first part of the verification, the first module 104 can comprise a first processor 112, a first memory 114 and a first communications device 116. Similarly, to perform the second part of the verification, the second module 106 can comprise a second processor 118, a second memory 120 and a second communications device 122.

The template can be divided into two different sets of data, one set being stored in the first memory 114 and another set being stored in the second memory 120. An advantage of having different sets stored in different parts of the system 100 is that the set stored in the first memory 114 may be information of less sensitive nature, that is, information that cannot be used on its own for recreating fingerprint information, while the set stored in the second memory 120 may be of more sensitive nature, that is, information that should not be spread. This combined with that a processing capability of the first processor 112 can be greater than a data processing capability of the second processor 118 provides for that verification operations involving significant data processing and template data of less sensitive nature can be performed in the first module 104 and verification operations involving less significant data processing and template data of sensitive nature can be performed in the second module 106.

In case it already in the first module 104 can be concluded that there is no match between the template and the sample, a first verification outcome 124 may be output from the first module 104. Alternatively, instead of or in addition to providing a binary statement, the first verification outcome 124 may comprise information about the verification performed in the first module 104. From the second module 106, a second verification outcome 126 may be output. This may be a binary statement of match or no match, but it may also be more detailed output comprising information about the verification performed in the second module 106.

In case the second module 106 is a smart card comprising the secure element, it is possible to instead of providing the second verification outcome 126, make crypto keys and functions on the smart card available such that external software may access these. This approach improves the security and makes fraudulent abuse more difficult.

FIG. 2 illustrates a more detailed illustration of the example generally illustrated in FIG. 1. More specifically, FIG. 2 illustrates how the system 100 can be used during an enrollment process by way of example.

As illustrated in FIG. 1, the sample 108 can be fed to the first module 104. To extract information from the sample, an extractor 200 can be used. The extractor 200 can be a piece of software stored on the first memory 114 and executed by using the first processor 112. The extractor 200 can have dual purposes. On one hand, it can provide for that the descriptors 202 are extracted from the sample 108 and on another hand, it provides for that key points 204 can be extracted. A difference in this context between descriptors 202 and key points 204 is that descriptors 202 are descriptions of general visual features in the sample 108, while the key points 204 are fingerprint specific features, such as points or areas of specific relevance for fingerprint comparison purposes. As illustrated, the descriptors 202 can be stored in the first memory 114 and the key points 204 may be transferred to the second module 106 and stored in the second memory 120.

The descriptors 202 may be based on the key points 204. More particularly, the descriptors 202 may be based on information gathered from areas surrounding the key points 204. For instance, if a swirl center of the finger print is identified as the key point, an area surrounding the swirl center may be used as basis for the descriptor.

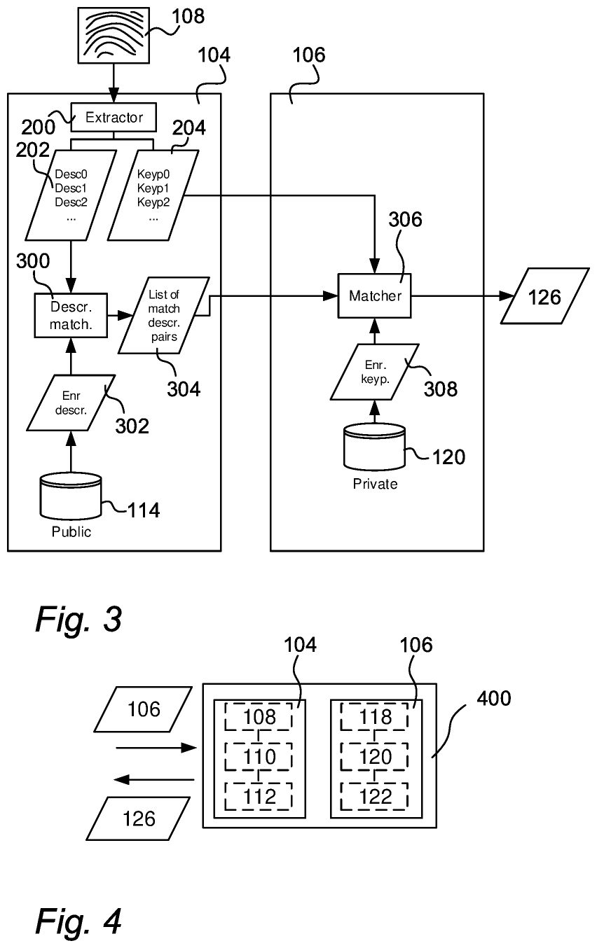

FIG. 3 illustrates how the system 100 can be used during a verification process by way of example.

In line with the enrollment process, the sample 108 can be received by the first module 104, and the descriptors 202 and the key points 204 can be extracted from the sample by using the extractor 200.

After having extracted the descriptors 202 and the key points 204, the descriptors 202 can be transferred to a descriptor matcher 300. In addition to the descriptors 202, enrolled descriptors 302, that is, descriptors transferred to the first memory 114 during the enrollment process, retrieved from the first memory 114 are fed to the descriptor matcher 300. Next, the descriptor matcher 300 can compare the descriptors 202 and the enrolled descriptors 302, which forms part of the template, to form a list 304 of matching descriptor pairs, that is, a list of points or areas in the sample 108 that are to be found both among the descriptors 202 and the enrolled descriptors 302. A matching descriptor pair may comprise one point or area found both among the descriptors as well as the enrolled descriptors. Put it in other words, one point or area among the descriptors which may match one point or area among the enrolled descriptors.

The list 304 of matching descriptor pairs and the key points 204 can be transferred from the first module 104 to a matcher 306 in the second module 106. In addition to the list 304 and the key points 204, enrolled key points 308 can be retrieved from the second memory 120 and be fed into the matcher 306. In the matcher 306, the key points 204 can be compared with the enrolled key points 308 in order to determine whether the two originates from the same finger, i.e. that it can be verified that the finger related to the sample 108 is the same finger as was used during the enrollment process.

By also providing the list 304 of matching descriptor pairs, the matcher 306 can be provided with additional input, thereby making it possible to achieve a higher degree of certainty. For instance, by using the list 304, more particularly using a number of identified pairs and to what degree these pairs are found to match, in combination with a comparison of the key points 204 and the enrolled key points 308, for instance a number of matching key points pair and to what degree they match, a similarity score can be determined. In case the similarity score is above a threshold, a positive verification outcome can be output.

FIG. 4 illustrates an embodiment in which part of the system 100 is comprised in a smart card 400. More particularly, the smart card 400 may comprise the first module 104 and the second module 106. The smart card 400 may be used for different applications where an identity of the user is to be confirmed. For instance, the smart card 400 may be a payment card. The first module 104 may be a micro-controller unit (MCU) and the second module 106 may be a secure element (SE).

The sample 106 may be provided to the smart card 400 via a mobile phone equipped with the fingerprint reader 102 or the smart card itself may comprise the fingerprint reader 102, even though not illustrated.

The smart card 400 may be configured to communicate with external devices using for example contactless near-field communication (NFC).

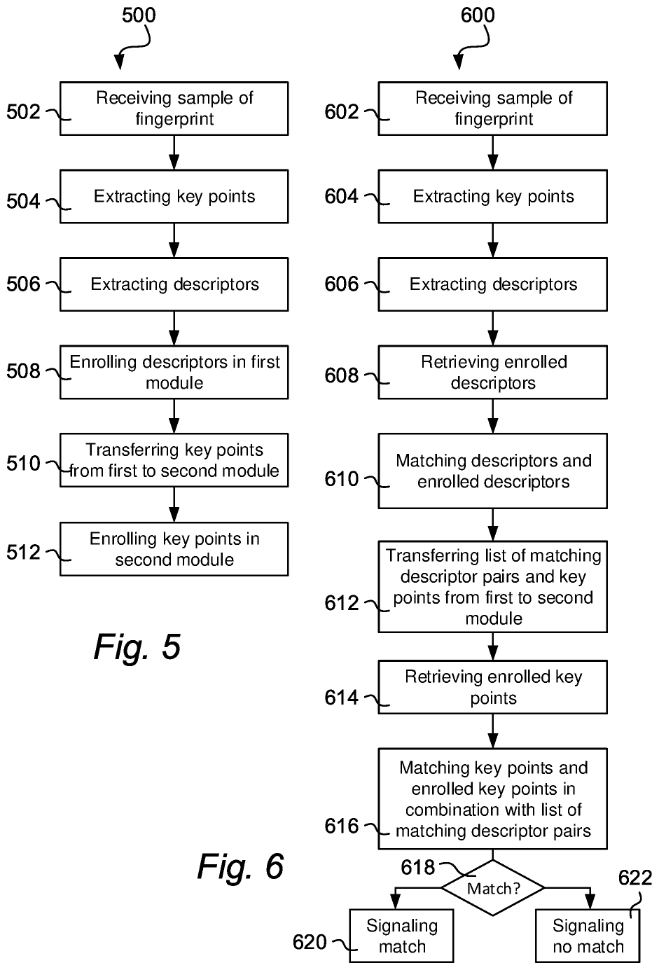

FIG. 5 is a flowchart illustrating a method 500 for fingerprint enrollment of the user by using the system 100.

First, the sample 102 can be received 502.

Next, the key points 204 can be extracted 504 from the sample 102 by using the first processor 112, and the descriptors 202 can be extracted 506. The descriptors (202) may be based on information gathered from areas surrounding the key points (204).

The descriptors 202 can be enrolled 508 in the first module 104, while the key points 204 can be transferred 510 to the second module 106 and enrolled 512 in the second module 106.

As can be readily understood by the skilled person in the art, the flow chart illustrated in FIG. 5 presents one out of many possible orders of the steps involved in the enrollment process.

FIG. 6 is a flow chart illustrating a method 600 for fingerprint verification.

First, the sample 108 of the fingerprint from the user can be received 602 by the first module 104.

Thereafter, the key points 204 from the sample 108 can be extracted 604 by using the first processor 112. Further, the descriptors 202 can be extracted 606 from the sample 108 by using the first processor 112. The descriptors (202) may be based on information gathered from areas surrounding the key points (204).

The enrolled descriptors 302 can be retrieved 608 from the first memory 114.

Next, the descriptors 202 and the enrolled descriptors 302 can be matched 610 by using the first processor 112, thereby forming the list 304 of matching descriptor pairs.

The list 304 of matching descriptor pairs and the key points 204 can be transferred 612 from the first module 104 to the second module 106 by using the first and second data communications device 116, 122.

The enrolled key points 308 can be retrieved 614 from the second memory 120.

Thereafter, the key points 204 and the enrolled key points 308 can be matched in combination with the list 304 of matching descriptor pairs using the second processor 118.

In case of match 618, a positive verification outcome can be signaled 620 by using the second data communications device 122, else, a negative verification outcome can be signaled 622 using the second data communications device 122.

By having the list 304 of matching descriptor pairs and since the descriptors 202 can be based on the key points 204, information on which of the key points 204 and the enrolled key points 308 that correspond to each other can be indirectly provided. This may be utilized in different ways. For instance, the information may be used for aligning the key points 204 and the enrolled key points 308 or it may be taken into account during the comparison by for instance determining differences, such as translational and rotational differences, between the key points 204 and the enrolled key points 308.

As can be readily understood by the skilled person in the art, the flow chart illustrated in FIG. 6 presents one out of many possible orders of the steps involved in the verification process.

From the description above follows that, although various embodiments of the invention have been described and shown, the invention is not restricted thereto, but may also be embodied in other ways within the scope of the subject-matter defined in the following claims.

1. A method for fingerprint verification of a user by using a system comprising a first module provided with a first processor, a first memory and a first data communications device, and a second module provided with a second processor, a second memory and a second data communications device, the method comprising
receiving a sample of a fingerprint from the user by the first module,
extracting key points from the sample using the first processor,
extracting descriptors from the sample using the first processor, wherein the descriptors are based on information gathered from areas surrounding the key points,
retrieving enrolled descriptors from the first memory, matching the descriptors and the enrolled descriptors using the first processor, thereby forming a list of matching descriptor pairs, transferring the list of matching descriptor pairs and the key points from the first module to the second module (106) using the first and second data communications device,
retrieving enrolled key points from the second memory, matching the key points and the enrolled key points in combination with the list of matching descriptor pairs using the second processor, and
in case of match, signaling a positive verification outcome using the second data communications device, else, signaling a negative verification outcome using the second data communications device.

2. The method according to claim 1, wherein the step of extracting sample descriptors from the sample by using the first processor is performed by using a general-purpose image analysis algorithm for identifying descriptors, and
wherein the step of extracting sample key points from the sample by using the first processor is performed by using a fingerprint specific algorithm for identifying key points and the position data and the direction data associated to the key points.

3. The method according to claim 1, wherein for each descriptor of the sample descriptors and the enrolled descriptors, a combination of features related to any one selected from a group consisting of colour, texture, shape, motion and location is provided.

4. The method according to claim 1, wherein an operating speed of the first processor is greater than an operating speed of the second processor.

5. The method according to claim 1, wherein the first module is a micro-controller unit (MCU) and the second module is a secure element (SE).

6. The method according to claim 1, wherein the first module and the second module are provided on a smart card.

7. A method for fingerprint enrollment of a user by using a system comprising a first module provided with a first processor, a first memory and a first data communications device, and a second module provided with a second processor, a second memory and a second data communications device, the method comprising
receiving a sample of a fingerprint from the user by the first module,
extracting key points from the sample using the first processor,
extracting descriptors from the sample using the first processor, wherein the descriptors are based on information gathered from areas surrounding the key points,
enrolling the descriptors to the first memory, thereby forming enrolled descriptors stored on the first memory,
transferring the key points from the first module to the second module, and
enrolling the key points to the second memory, thereby forming enrolled key points stored on the second memory.

8. A first module, such as a micro-controller unit (MCU), comprising
a first processor,
a first memory and
a first data communications device,
wherein the first module is configured to
receive a sample of a fingerprint from the user by the first module,
extract key points from the sample using the first processor,
extract descriptors from the sample using the first processor,
retrieve enrolled descriptors from the first memory,
match the descriptors and the enrolled descriptors using the first processor, thereby forming a list of matching descriptor pairs, and
transfer, using the first data communications device, the list of matching descriptor pairs and the key points from the first module to a second module, such as a secure element (SE), comprising
a second processor,
a second memory, and
a second data communications device,
wherein the second module is configured to
receive the list of matching descriptor pairs and the key points from the first module using the second data communications device,
retrieve enrolled key points from the second memory,
match the key points and the enrolled key points in combination with the list of matching descriptor pairs, and
in case of match, signal a positive verification outcome using the second data communications device, else, signal a negative verification outcome using the second data communications device.

9. The second module, such as the secure element (SE), comprising
the second processor,
the second memory, and
the second data communications device,
wherein the second module is configured to
receive the list of matching descriptor pairs and the key points from the first module according to claim 8 using the second data communications device,
retrieve enrolled key points from the second memory,
match the key points and the enrolled key points in combination with the list of matching descriptor pairs, and
in case of match, signal a positive verification outcome using the second data communications device, else, signal a negative verification outcome using the second data communications device.

10. A system comprising
a first module, such as a micro-controller unit (MCU), and a second module, such as a secure element (SE),
wherein the first module comprises
a first processor,
a first memory and
a first data communications device,
wherein the first module is configured to
receive a sample of a fingerprint from the user by the first module,
extract key points from the sample using the first processor,
extract descriptors from the sample using the first processor,
retrieve enrolled descriptors from the first memory,
match the descriptors and the enrolled descriptors using the first processor, thereby forming a list of matching descriptor pairs, and
transfer, using the first data communications device, the list of matching descriptor pairs and the key points from the first module to the second module,
wherein the second module comprises
a second processor,
a second memory, and
a second data communications device,
wherein the second module is configured to
receive the list of matching descriptor pairs and the key points from the first module using the second data communications device,
retrieve enrolled key points from the second memory,
match the key points and the enrolled key points in combination with the list of matching descriptor pairs, and
in case of match, signal a positive verification outcome using the second data communications device, else, signal a negative verification outcome using the second data communications device.

11. The system according to claim 10, wherein the system is a smart card.

12. The system according to claim 10, further comprising a finger print reader for capturing the sample of the fingerprint.

13. The system according to claim 10, wherein the system is part of a payment solution.

14. A non-transitory computer-readable medium having stored thereon instructions which, when the program is for implementing the method according to claim 1, when executed on the first module and the second module having processing capabilities.

15. A non-transitory computer-readable medium having stored thereon instructions for implementing the method according to claim 7, when executed on the first module and the second module having processing capabilities.
